(19) United States
(12) Patent Application Publication
(10) Pub. No.: US 2007/0012078 A1
(43) Pub. Date: Jan. 18, 2007

(54) Method for providing a nutrient-enriched aquarium waste-water for plant watering

(76) Inventors: Debra A. Holms, Germantown, WI (US); Rory J. Holms, Germantown, WI (US)

Correspondence Address: JANSSON, SHUPE, MUNGER & ANTARAMIAN, LTD, 245 MAIN STREET, RACINE, WI, 53403, US

(21) Appl. No.: 11/179,895

(22) Filed: Jul. 12, 2005

(51) Int. Cl. C05D 9/02

(52) U.S. Cl. 71/1

(57) ABSTRACT

A method for providing a nutrient-enriched aquarium waste-water for plant watering, comprising the steps of: adding a fresh clean water to an aquarium; determining a time point when the aquarium water becomes a waste-water deleterious to fish but rich in nutrients beneficial for plants; removing at least a portion of aquarium waste-water from the aquarium into a receptacle; and selling the aquarium waste-water as a plant fertilizer.

### FIELD OF THE INVENTION

This invention relates in general to fertilizers. More particularly, to a method for providing easily available ready-to-use liquid fertilizer for watering plants.

### BACKGROUND OF THE INVENTION

It is known, of course, that aquarium water is rich in nitrogen and phosphorus and it is also known to pour such aquarium waste-water on house-plants, yard and vegetable garden, hereafter for convenience referred to simply as “plants.” Aquarium water is rich with nitrates provided by a breakdown of products of the fish's metabolism and further bacterial breakdown which constitutes a fertilizer for plants. Therefore, the dirty aquarium water is a ready-to use liquid fertilizer which does not need to be diluted or aged.

However, many households do not have aquariums, thus, do not have access to nutrient-enriched aquarium waste-water. It would be desirable to have a method for providing such liquid fertilizer to people not possessing aquariums. It becomes specially relevant in the light of dirty aquarium water being emptied into a sewage system. This occurs because routine aquarium maintenance cycle requires water-exchange be performed rather often. Each cleaning produces aquarium waste-water in amounts significantly exceeding the need for watering plants in a given household. Thus, it would be beneficial to have a method for disposing of aquarium water in a way that reduces the burden on municipal waste-water treatment operations and reduces the demand for clean water, the method that will somewhat address important environmental issues of waste disposal and water preservation.

Furthermore, repeating aquarium water-exchange creates a risk of such water being discarded into storm-sewer systems which often do not have any treatment of water flowing into natural water bodies (e.g., lakes, rivers etc.). This presents a risk of aquarium-bred plants suppressing and interfering with the wild aquatic flora. A method of recycling aquarium waste-water would be advantageous in reducing a risk of such ecological problem.

### OBJECTS OF THE INVENTION

It is an object of the invention to furnish a method for providing a nutrient-enriched aquarium waste-water for plant watering which addresses some of the issues referred to above.

Another object of the invention is to provide a method for regular supply of aquarium waste-water as a liquid plant-fertilizer to people without access to aquariums.

Another object of the invention is to provide a method for disposing of aquarium water in a way that decreases the burden on municipal waste-water treatment operations and reduces the demand for clean water.

Still another object of the invention is to provide a method of recycling aquarium waste-water which lessens a chance of introduction of aquarium-bred plants to natural water-bodies and lowers a risk of aquarium-bred plants suppressing and interfering with the wild aquatic flora.

How these and other objects are accomplished will become apparent from the following descriptions and the drawings.

### SUMMARY OF THE INVENTION

This invention, which will be described in detail below, is a method for providing a nutrient-enriched aquarium waste-water for plant watering.

The present invention provides a method which allows systematic access to nutrient-enriched aquarium water for people not possessing aquariums. The present invention provides a method of re-using dirty water removed from aquariums when performing aquarium-cleaning. The present invention also presents a way of recycling aquarium waste-water by utilizing its valuable characteristics as a liquid fertilizer and thus reducing a burden on municipal waste-water treatment operations and decreasing the demand for clean water. Furthermore, the method of this invention substantially eliminates a risk of aquarium-bred plants getting into natural water bodies with the aquarium waste-water disposed into storm-sewer system.

The inventive method includes: adding a fresh clean water to an aquarium; determining a time point when the aquarium water becomes a waste-water deleterious to fish but rich in nutrients beneficial for plants; removing at least a portion of aquarium waste-water from the aquarium into a receptacle; and selling the aquarium waste-water as a plant fertilizer. There is preferably at least one fish in the aquarium prior to the adding of fresh clean water.

The nitrogen cycle is completed by the breakdown of fish waste through the use of beneficial bacteria, such as Nitrosomonas, Nitrobacter or similar soil bacteria present in fish-tanks. The bacteria uses fish waste, plant decay, and excess fish-food waste as a food source to convert ammonia caused by the above activities into nitrites. These nitrites are further reduced by bacteria to nitrates which in turn are beneficial plant-food. The above-described process creates a valuable liquid fertilizer for plants.

The determination of the time point when the aquarium water becomes a waste-water deleterious to fish but rich in nutrients beneficial for plants may vary depending on the type of the fish, its size and number. The time for water-change also effected by the size of the aquarium. Typically, small jar-type aquariums require to have water-change every few days. On the other hand, once a week is appropriate to withdraw and replenish water from larger aquarium tanks. Taking into account all of the above factors, the determination step of the present invention simply involves establishing a calendar for the aquarium water-changes.

In certain preferred examples of the method of this invention, the receptacle of the aquarium waste-water is a readily-portable container. The aquarium waste-water is sold in pre-filled readily-portable containers.

Throughout this summary section and elsewhere in this specification the term “readily-portable” refers to jars and the like which may be gripped in a hand; one-hand portability depends upon size and whether there is a suitable grip, such as the neck or width of the jar and/or a handle to facilitate pouring. Preferably, the readily-portable containers have a capacity of three and less gallons.

In other highly preferred examples of the method of this invention, the receptacle is a not-readily-portable canister. Whereby the waste-water is removed from the aquarium into the canister. The waste-water then may be sold as a fertilizer in such canister. Alternatively such fertilizer may be sold by dispensing from the canister.

In some preferred examples, the method further includes a step of setting up a station for dispensing the waste-water from the canister.

In certain instances of the highly preferred examples, the canister has at least one out-pouring valve, and the method further includes a step of dispensing the aquarium waste-water from the canister through such out-pouring valve into readily-portable containers prior to the selling of the aquarium waste-water.

The term “not-readily-portable” as used herein refers to large-capacity tanks which can hold a great volume of liquid. Lifting or moving of such tanks may require a great effort or even special equipment.

In the method of the present invention the fresh clean water is substantially free of chlorine and other chemicals harmful to fish or plants. The fresh clean water may initially be a tap, distilled, de-ionized, filtered or water from a fresh-water-well. Variety of dechlorination procedures of a tap-water may be performed prior to adding such water to the aquarium. One of such procedures may involve passing of the tap water through a filter deterring chlorine and other chemicals harmful to fish or plants.

### BRIEF DESCRIPTION OF THE DRAWINGS

FIG. 1 is a diagram of a method of the present invention.

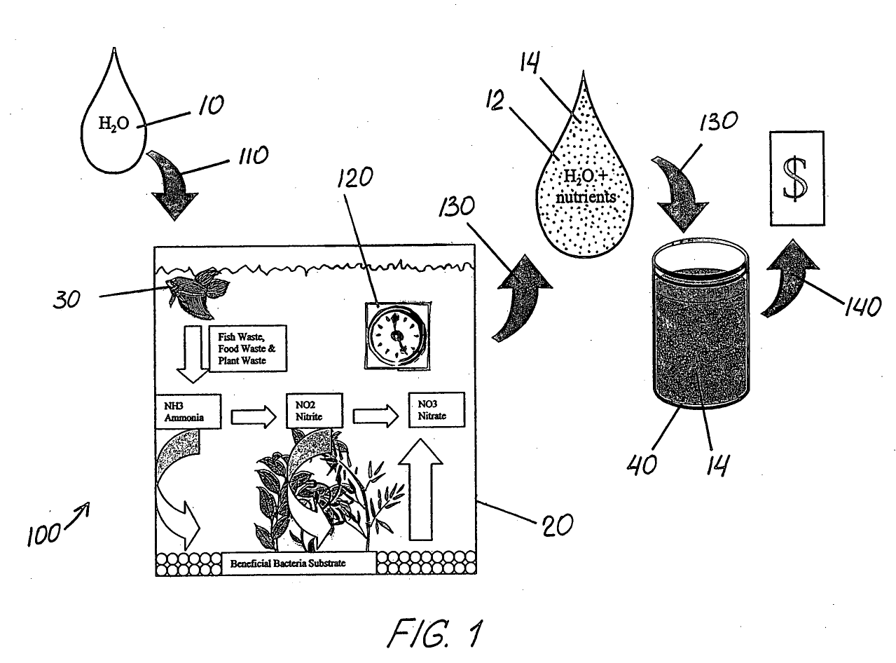

FIG. 2 is a diagram of an example of the method of FIG. 1.

FIG. 3 is a diagram of another preferred example of the method of FIG. 1.

### DETAILED DESCRIPTION OF PREFERRED EMBODIMENTS

This invention, which will be described in detail below, is a method for providing a nutrient-enriched aquarium waste-water for plant watering.

The present invention provides a method which allows systematic and continues access to nutrient-enriched aquarium water for people not possessing aquariums but wishing to apply such ready-to-use liquid fertilizer on their plants. The present invention also presents a way of utilizing characteristics of aquarium waste-water as a nutrient-enriched liquid fertilizer, and provides a method of re-using dirty water removed from aquariums during cleaning, thus reducing a burden on municipal waste-water treatment operations and decreasing the demand for clean water. Furthermore, the method of this invention substantially eliminates a risk of aquarium waste-water getting into natural water bodies by presenting an alternative way of disposing such water rather than discarding it into storm-sewer system. Direct access of storm-sewer system into lakes and rivers without depuration presents a great danger of aquarium-bred plants suppressing and interfering with the wild aquatic flora.

Referring to the FIGURES, the inventive method 100 includes steps of: adding 110 a fresh clean water 10 to an aquarium 20; determining 120 a time point when the aquarium water becomes a waste-water 12 deleterious to fish 30 but rich with nutrients beneficial for plants; removing 130 at least a portion of aquarium waste-water 12 from aquarium 20 into a receptacle 40; and selling 140 aquarium waste-water 12 as a plant fertilizer 14. There is preferably at least one fish 30 in aquarium 20 prior to adding 110 of fresh clean water 10.

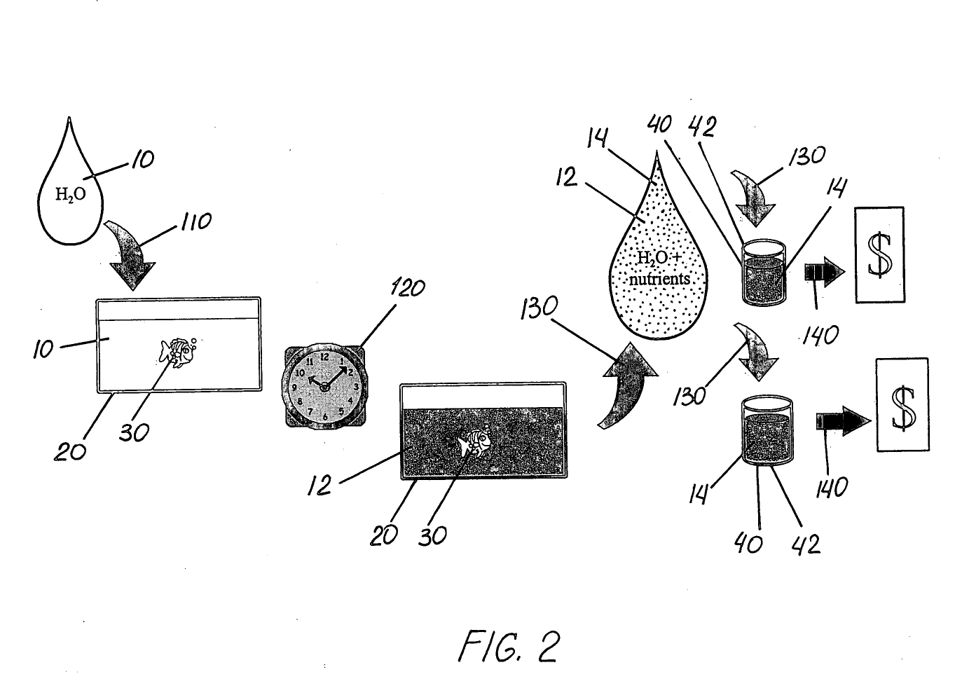

As seen on FIG. 2, in certain preferred examples of method 100 of this invention, receptacle 40 is a readily-portable container 42 and aquarium waste-water 12 is sold in pre-filled readily-portable containers 42.

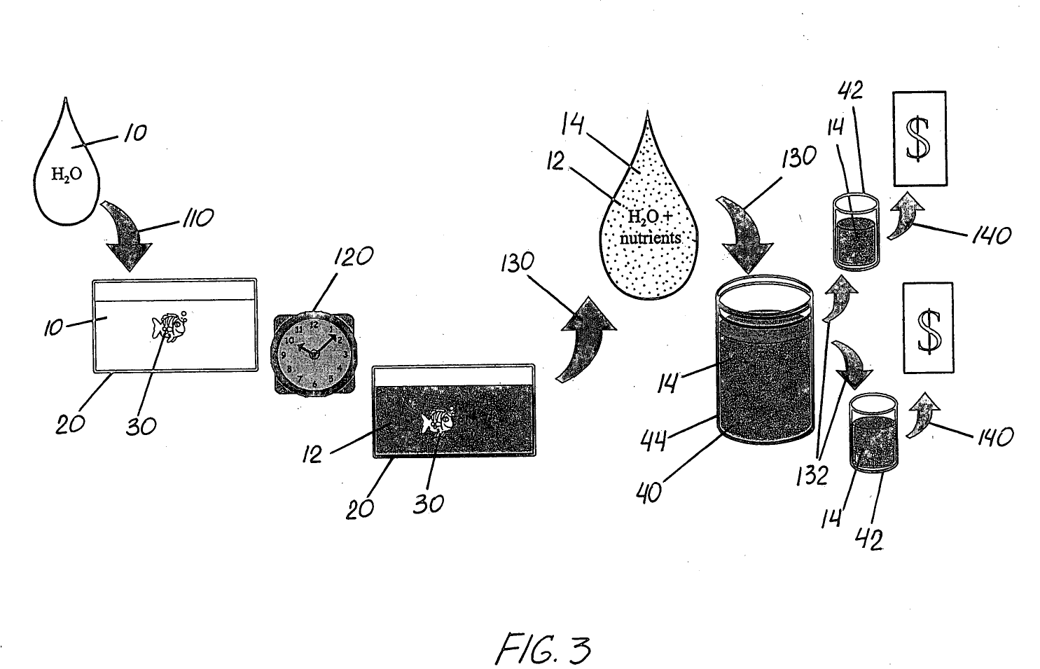

FIG. 3 illustrates another preferred example of method 100 having receptacle 40 as a not-readily-portable canister 44, whereby aquarium waste-water 12 is sold as a ready-to-use liquid fertilizer 14 by dispensing from canister 44.

In certain instances of such examples, canister 44 has at least one out-pouring valve (not shown) and the method 100 may include a step 132 of setting up a station for dispensing the waste-water from the canister into readily-portable containers 42 prior to selling 140 of aquarium waste-water 12 as a plant fertilizer 14.

While the principles of the invention have been shown and described in connection with specific embodiments, it is to be understood that such embodiments are by way of example and are not limiting.

1. A method for providing a nutrient-enriched aquarium waste-water for plant watering, comprising the steps of:
adding fresh clean water to an aquarium;
determining a time point when the aquarium water becomes a waste-water deleterious to fish but rich in nutrients beneficial for plants;
removing at least a portion of aquarium waste-water from the aquarium into a receptacle; and
selling the aquarium waste-water as a plant fertilizer.

2. The method of claim 1 wherein there is at least one fish in the aquarium prior to the adding of fresh clean water.

3. The method of claim 1 wherein the receptacle is a readily-portable container and the aquarium waste-water is sold in pre-filled readily-portable containers.

4. The method of claim 1 wherein the receptacle is a not-readily-portable canister, whereby the aquarium waste-water is sold by dispensing from the canister.

5. The method of claim 4 further includes a step of setting up a station for dispensing the waste-water from the canister.

6. The method of claim 5 wherein the canister includes at least one out-pouring valve and the method further includes the step of dispensing the aquarium waste-water from the canister through the out-pouring valve into readily-portable containers prior to the selling of the aquarium waste-water.

7. The method of claim 1 wherein the fresh clean water is substantially free of chlorine and other chemicals harmful to fish or plants.
